(19) United States
(12) Patent Application Publication
(10) Pub. No.: US 2019/0203524 A1
(43) Pub. Date: Jul. 4, 2019

(54) GARAGE DOOR RESTORATION OVERLAY PANELS

(71) Applicant: Jeffrey Nero, Shrewsbury, NJ (US)

(72) Inventor: Jeffrey Nero, Shrewsbury, NJ (US)

(21) Appl. No.: 16/151,119

(22) Filed: Oct. 3, 2018

Related U.S. Application Data
(60) Provisional application No. 62/610,985, filed on Dec. 28, 2017.

(51) Int. Cl. E06B 3/70; E06B 3/48

(52) U.S. Cl. CPC E06B 3/7001; E06B 3/485; E06B 2003/7044; E05Y 2900/106; E05Y 2201/11

(57) ABSTRACT

A garage door magnetic overlay system comprised of a plurality of magnetic overlay sections for attaching to a front surface of an existing garage door to renovate and change the appearance of the existing garage door. Each of the magnetic overlay sections is made of a neodymium-magnetic steel core with a matte printed front surface and a high-friction coating on the rear surface. One of the plurality magnetic overlay panels attaches to each panel of the existing garage door including at least one top panel and one bottom panel.

### CROSS-REFERENCE TO RELATED APPLICATIONS

This application claims priority to U.S. Provisional Application No. 62/610,985 filed Dec. 28, 2017, which is incorporated by reference in its entirety.

### FIELD OF THE DISCLOSURE

This disclosure relates generally to the field of garage doors, and more particularly, to a garage door overlay, a garage door overlay system, and a method of restoring and renovating metal garage doors.

### BACKGROUND

The classic look of garage doors has remained essentially unchanged over the last 30 years, and currently available garage doors continue to exhibit the almost same exact look. A current trend has begun where homeowners update these basic doors with newer, different designs, but these replacement garage doors are very expensive. Additionally, as garage doors age they often start to fade and show their age and any damage sustained over the years. When a homeowner wants to replace their garage doors to update the style or replace aged doors, the homeowner not only incurs the cost of buying the new doors, but they also typically need to pay a contractor to install the new doors as well.

There have been some attempts to solve the problems in the prior art, including the rise of cheap metal garage doors. Although these cheap garage doors are functional, they often lack the aesthetically pleasing look of a wood garage door. Often, homeowners replace their metal garage doors with new metal garage doors, as they cannot afford to replace their garage doors with the expensive aesthetically pleasing wood garage doors. Many homeowners want a cheap garage door replacement or repair, while being able to maintain the appearance of a wood door.

Other attempted solutions to the problems in the prior art include the trend in building of utilizing wooden overlays. A wooden overly normally comprises a thin panel of real wood, that are often stained with a wood finish, that is placed over an existing garage door. These wooden overlaid doors can be very expensive, are prone to water becoming trapped between the original door and the wooden overlaid door causing rot, and deterioration due to exposure to sunlight and the elements.

U.S. patent application Ser. No. 10/794,505 is an example of existing attempts to address the shortcomings of conventional garage door repair or replace problems. In this patent application a realistic digital photographic image is reduced on the surface of an overhead door, giving it the appearance of a realistic object such as an overhead door, or a nature scene. In the '505 patent application, a digital photographic image is divided into portions, with each portion corresponding to a panel on the garage door. The digital photographic image portions are either printed directly onto the overhead door panels prior to the delivery to the client or the digital photographic image portions are printed on a set of panels that are subsequently attached to the garage door. This patent application, however, does not sufficiently provide a fast or weatherproof enough long-term solution to make an old garage door aesthetically pleasing.

Due to all of the existing shortcoming in presently available garage door covers, there is still a need for a garage door cover that corrects the short comings in the prior art.

### SUMMARY

The disclosure presented herein relates to a garage door magnetic overlay and overlay system comprised of a plurality of magnetic overlay panels for attaching to a front surface of an existing garage door to renovate and modify the appearance of said existing garage door. One of the plurality magnetic overlay panels attaches to each panel of the existing garage door, including at least one top panel and one bottom panel. Further, each of the magnetic overlay panels comprises a magnetic steel core with drain grooves scored on the back side, a high-friction coating, a front side matte surface. Further, the upper and lower panels have beveled edges that serve to hide any panel gap. Those of ordinary skill will appreciate that other uses may be foreseeable also and are included within the scope of the present description.

In one aspect, one or more embodiments for a method of renovating a garage door comprised of attaching a plurality of magnetic overlay panel to a front side of each panel of a plurality of panels of an existing garage door. The magnetic overlay panel comprising drain grooves sored onto their back side, a high-friction coating on their back side, and a matte surface on their front side. Additionally, the method further comprising one or more overlapping beveled edge on at least one panel of the plurality of magnetic overlay panels.

The present invention discloses a device and apparatus to cosmetically improve the appearance of an old or unfashionable garage door.

A magnetic, ornamental overlay for garage doors is disclosed. Said overlay features a magnetic fastening means, a backing that resists slippage and prevents water buildup, and a UV-resistant decorative surface.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

For a more complete understanding of the present invention, the objects and advantages thereof, reference is now made to the ensuing descriptions taken in connection with the accompanying drawings briefly described as follows.

FIG. 1 is a front view of four exemplary garage door overlay sections, according to various aspects of the present disclosure

FIG. 2 is an exploded view of the four exemplary garage door overlay sections depicted in FIG. 1.

FIG. 3 is a perspective view of an exemplary garage door overlay section being attached to a panel of a garage door, according to various aspects of the present invention.

FIG. 4 is a rear view of an exemplary garage door overlay section, according to various aspects of the present invention.

FIG. 5 is a side view of an exemplary garage door overlay section attached to a garage door panel, according to various aspects of the present invention.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present description includes one or more embodiments for a magnetic garage door overlay and overlay system that may be placed on top of a garage door panel, where the system is comprised of a plurality of magnetic garage door overlays for attaching to a front surface of an existing garage door panel to renovate and modify the appearance of said existing garage door. The one or more embodiments for a magnetic garage door overlay include multiple elements for applying magnetic overlays onto an existing garage door. For example, in one non-limiting embodiment, the system is comprised of a plurality of magnetic overlays, including at least one top panel and one bottom panel. Elements included herein are meant to be illustrative, rather than restrictive. Persons having ordinary skill in the art relevant to the present disclosure may understand there to be equivalent elements that may be substituted with the present disclosure without changing the essential function or operation of the device.

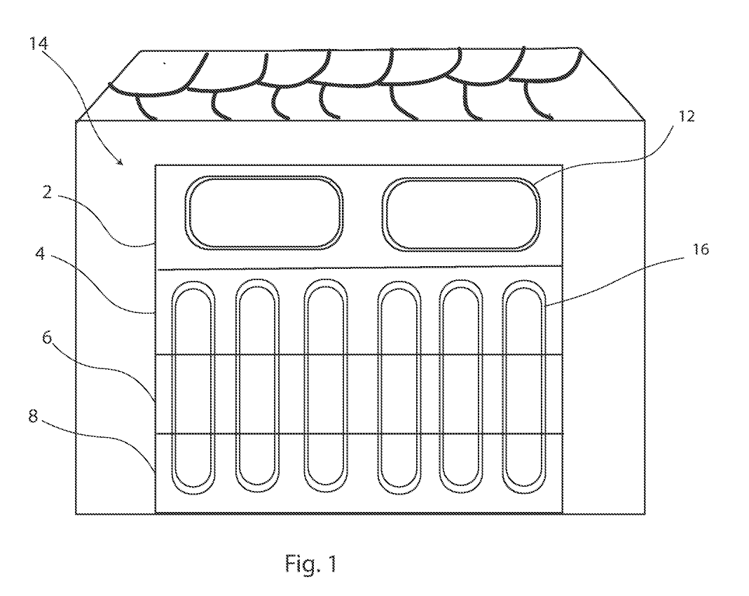

Preferred embodiments of the present invention and their advantages may be understood by referring to FIGS. 1-5, wherein like reference numerals refer to like elements.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 is a front view of four exemplary garage door overlay sections 14, according to various aspects of the present disclosure. The garage door overlay sections 14 include top section overlay 2, upper middle section overlay 4, lower middle section overlay 6, and bottom section overlay 8. In one embodiment, the garage door overlay sections 14 are comprised of a semi-rigid steal core overlay made in precise widths and lengths to cover each metal panel section of an existing garage door panel. This allows a user to place each garage door section overlay section over an existing metal garage door panel, and the garage door section overlay will magnetically stick to said garage door panel allowing for easy updating of the cosmetic/esthetic look of a homeowner's garage door. The most common garage doors come in three, four, or five horizontal panel designs with either recessed squares or rectangular shapes.

The most common metal garage door usually come in 3, 4, and 5 horizontal panel sections with either recessed square or rectangular shapes. In FIG. 1, four garage door overlay sections 14 are used, but in another embodiment, one or more garage overlay sections are used, depending on the how many garage door panels need to be covered on an existing garage door.

In one embodiment, the overlay, such as overlays 2,3,6, and 8, are made from thin sheets of steel, and can vary in number from one to five panels assembled vertically to fold as the garage doors can roll up toward the ceiling when closed.

In one non-limiting embodiment, the overlays are a rigid or semi-rigid made of a neodymium magnetic core. In other embodiments, the magnetic core is made of another magnetic material and the thickness can vary depending on factors, such as, thickness limitations on the garage door the panels will be placed on. Additionally, as described in greater detail below, the overlays can also have a printable UV inhibiting front, a high-friction rear coating, and a beveled overlapping edge.

The garage door overlay sections are a minimum thickness of 30 mil or 0.03″ but, in some embodiments, can also have a thickness greater and less than the standard 30 mil depending on the existing metal garage door type. For example, an existing smooth/flush metal garage door with no ornamental shape, recesses, or windows originally constructed into it, can utilize a thinner system while a wider gapped recessed shaped metal garage door will utilize a thicker system for its rigidity.

As shown in FIG. 1, the front side of the garage door overlay sections 14 can be printed to give them a unique design. This can include any form of printing or engravings, or applying materials such as thin vinyl, layered PVC, and rubber materials to give the overlays an imitation look of other wood or metal garage doors. In FIG. 1, the horizontal oval shapes 12 and vertical oval shapes 16 have been printed on top of the garage door overlay sections 14 to make said overlay sections appear as if they have recessed shapes as part of their look. In one embodiment, homeowners can choose from a selection of modern new door images from the classic carriage house look, to wood looking doors, and also a contemporary design. In one non-limiting embodiment, the garage door overlay sections applied images, or overlay systems, will not have the look of windows. This is because some existing garage doors already have real windows installed which can be unscrewed from the back to temporarily remove the window, cut the present overlay sections or panel system to remove that section, and then reinstall the window upon completion.

The garage door overlay section images can be stored in computer files available for review and selected by a customer. The file can be converted into computer instructions for controlling a printer to print the design. The printing process can be performed on a separate film to install on the magnetic steel core, or the printing can be done on an essentially complete magnetic steel core overlay. Further, exterior decorative hardware may be attached, such as antique-appearing hinges.

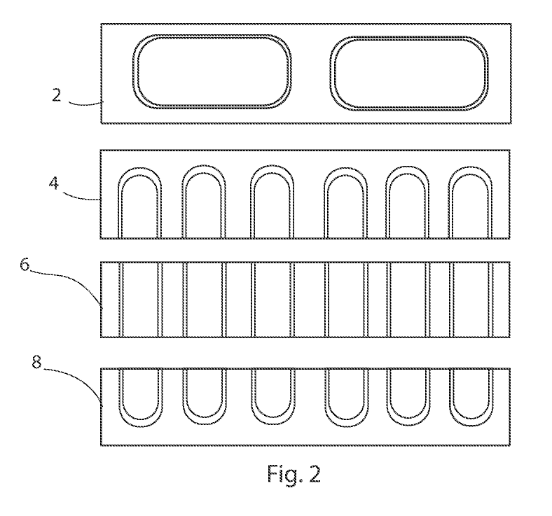

FIG. 2 is an exploded view of the four exemplary garage door sections depicted in FIG. 1. In this figure, garage door overlay sections 2,4, 6, and 8 are shown removed from the traditional metal garage door. This figure depicts how each overlay section, in this embodiment, are a near full-length and width of garage door panels that they will be placed on. By placing one overlay section per garage door panel, the user is able to easily refresh the look of an old garage door, and this design allows for the bending of a garage door when it is closed.

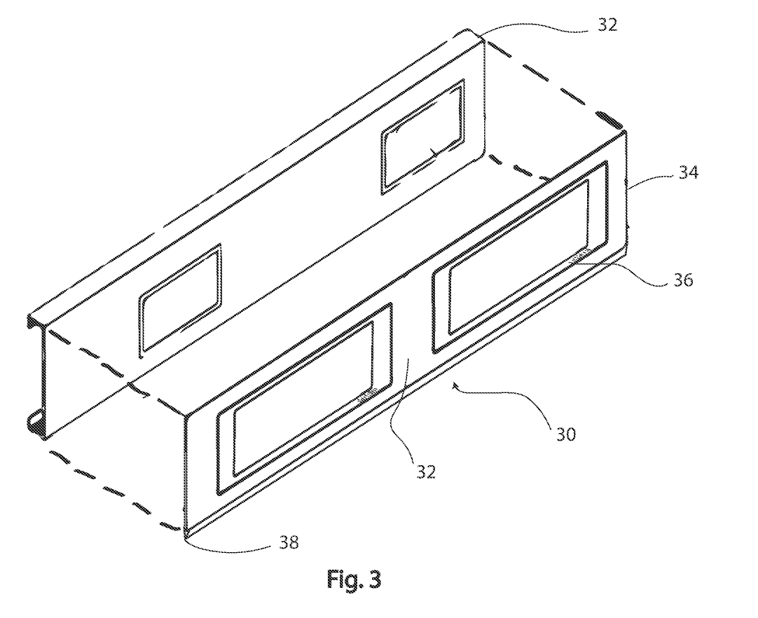

FIG. 3 is a perspective view of an exemplary garage door overlay section 30 being attached to a panel of a garage door 32, according to various aspects of the present invention. In this embodiment, the core 34 of the garage door overlay section 30 is a rigid neodymium magnetic core, around 30 millimeters thick. On the front surface of the core is printed image 32 that includes the rectangular design 36. The rectangular design 36 gives the garage door overlay section 30 a look as if it contains a recessed shaped design commonly found on traditional garage doors.

Additionally, on the front surface of the garage door overlay sections, such as the overlay section 30, damaging sunlight for hours on end will quickly fade any image printed, such as image 32, in relatively a short period of time. To counteract this deterioration, UV inhibitors are manufactured into the front matte surface of the panels while UV restrictive ink is used to protect the image 32. In another embodiment, when a thin vinyl, rubber, or layered PVC material designed to imitate the look of wood are applied to the front of the overlays for an even higher end appearance, a UV blocking inhibitor is sprayed over the surface to protect the material.

Additionally, as shown in FIG. 3, the bottom of the garage door overlay panel section 30 contains a beveled overlapping edge 38. The beveled overlapping edge 38 is used to limit the noticeability of the gaps between each stacked panel when the garage door is fully closed. In one embodiment, the upper and lower overlays have beveled edges which overlap so the front image is not distorted. In some embodiments, the bottom overlay section would not have an overlay because there are not overlay sections below it. Homeowners can choose from a selection of modern new door images from the classic carriage house, to wood looking doors, and also contemporary designs.

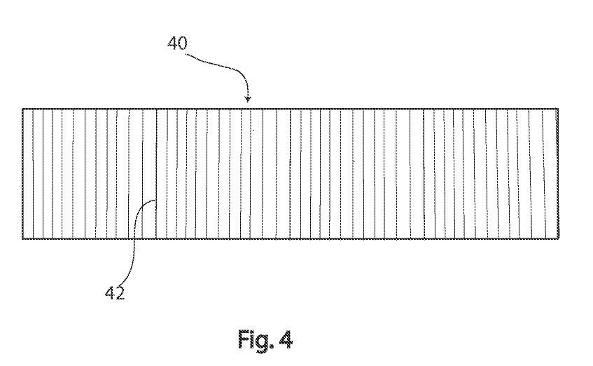

FIG. 4 is a rear view of an exemplary garage door overlay section, according to various aspects of the present invention. The overlay sections poise potential problems that need to be addressed. For example, problems can be caused by moisture, rain, and heat. When an overlay section is laid over a void, such as a rectangular recess of the existing garage door panel, two things can occur. First, rain water can get trapped between the existing garage door panel surface and the back of the overlay section 40 causing the metal doors to rust and deteriorate over time. Second, warm humid air as the day gets hotter, moves over a cold or cooler surface that is in the shade, causing the relative humidity to climb within the void. Condensation can form adding to the rusting of the existing doors as well. Another issue can arise with trapped heat from the sun within the void. This trapped heat and trapped rain water can cause a bubbling effect on the front image and the printed image on the overlay panels.

To solve these problems, the rear surface of the magnetic overlay section 40 can comprise thin 1/16″ grooves 42 scored into each steel overlay 40 perpendicular from top to bottom and spaced evenly along the entire width of horizontal panel. This creates channels to allow rain water and condensation to freely move behind the panel systems, as this ribbed pattern now creates an equilibrium between the two sides and ensures air cannot get trapped underneath.

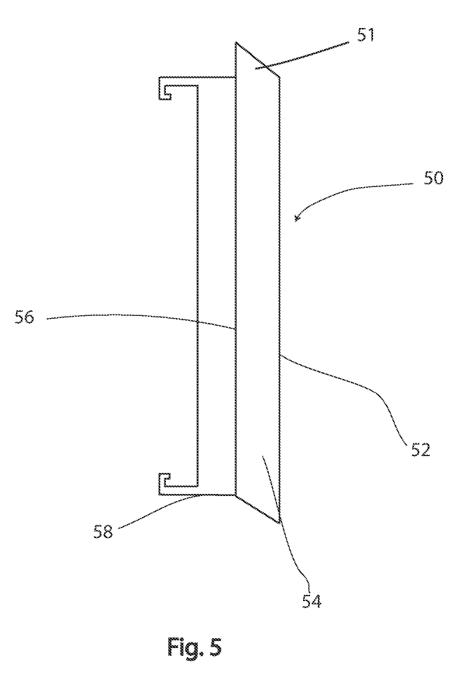

FIG. 5 is a side view of an exemplary garage door overlay section 50 attached to a garage door panel 58, according to various aspects of the present invention. While the magnetic force of the magnetic overlay section 50 possesses sufficient magnetic force to hold the overlay system vertically in place while not in motion. When the garage door opens or closes, the rubber weather stripping on either side of the doors rubs against the overlays, such as overlay 50, and can cause slippage or sliding of the panels out of alignment. Since every home's weather stripping at these side locations exhibits different variables, and the surface of the existing metal garage door panels 58 are relatively smooth due to the painted surface, the disclosed garage door overlay system uses a high-friction coating applied to the rear surface 56 to ensure overlay sections 50 stays in place and in alignment. This high friction coating can be a sprayed on coating, and gives more resistance to slipping.

The recessed shapes typically found in existing garage doors pose an issue to fitting an overlay section. Any thin material laid over these areas can conform to the outlines of the existing shapes, therefore will become noticeable, which this system seeks to avoid and hide from view. The garage door overlay panel sections, such as overlay section 50, use a minimum thickness 30 mil or 0.03 rigid, neodymium-magnetic steel core, but greater thicknesses or less thickness panels can be used depending on the existing door type and size of any recesses. For example, an existing smooth/flush door with no shapes originally constructed into it can utilize a thinner system, while a wider gapped recessed shape will utilize a thicker system panel for its rigidity.

Because the garage door overlay sections are exposed to the exterior elements, sun exposure can become problematic. Damaging sunlight for hours on end can quickly fade any printed image within a relatively short period of time. To counteract this deterioration, the white (or colored) exterior front matte surface 52 includes UV inhibitors manufactured into the front matte surface of the garage door overlay section 50, while included UV restrictive ink protects the image. In some embodiments, the front matte surface 52 can comprise a vinyl film or similar material adhered to the magnetic steel core 54 or can be a painted surface. In another embodiment, other surface applications can be applied to the magnetic steel core 54 forming the exterior front matte surface of garage door overlay such as acrylic-urethane-elastomeric coatings, other urethane coatings, plastic films, liquid vinyl, or the like.

Lastly, to limit the noticeability of the gaps between each stacked panel when fully closed, the garage door overlay sections, such as the upper section, upper middle section, lower middle section, and bottom section of FIG. 1, can use beveled edges, such as beveled edge 54 of FIG. 5, on an outer edge, which can overlap the edges of the door overlays, so the front image is not distorted. Additionally, as shown in this view, the garage door overlays can also have a top beveled edge 51. As shown in this view, the top beveled edge 51 points in an upwardly direction with the slanted surface facing the front of overlay. The top beveled edge 51 works with the beveled edge 54 to hide panel gap, as the inverse relationship in said edges helps to ensure the panel gaps are hidden.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

Advantageously, the present description provides one or more embodiments of various types of magnetic overlaid panels. Each magnetic overlaid panel depicted herein provides advantages that overcome shortcomings of other types of garage door paneling that are used conventionally. Further, the various embodiments shown in the figures and described herein accommodate different sized garage doors and may be used in various applications, including, but not limited, improving the aesthetics of an old garage door. It is noted that the various embodiments of pants garment presented herein may be used in many other ways other than to improve aesthetics. For example, the various magnetic overlaid panels may generally be used to improve the life of a garage door by protecting the garage door from the weather. Thus, the various embodiments described in the present description include a number of novel and helpful components that provide enhanced pants garment to benefit a user.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A garage door overlay section, comprising:
an elongated rectangular magnetic core;
a front matte surface;
a rear surface comprised of at least one scored groove and a high friction coating; and
at least one beveled edge.

2. The garage door overlay section of claim 1, wherein said at least one scored grooves is two or more 1/16″ evenly spaced vertical groove across an entire horizontal width of the rear surface.

3. The garage door overlay section of claim 1, wherein said elongated rectangular magnetic core is at least 0.3 mil thick and comprised of a rigid neodymium steel core.

4. The garage door overlay section of claim 1, wherein the front matte surface comprises at least one UV inhibitor manufactured into the front matte surface.

5. The garage door overlay section of claim 1, wherein the front matte surface further comprises a printed image.

6. The garage door overlay section of claim 5, wherein said printed image is comprised of UV restrictive ink.

7. The garage door overlay section of claim 1, wherein the front matte surface printed image comprises at least one of a classic carriage house look, a wood looking door look, and a contemporary design look.

8. The garage door overlay section of claim 1, where said at least one beveled edge is on a top or a bottom surface of said elongated rectangular magnetic core.

9. The garage door overlay section of claim 1, wherein said magnetic core panel is configured to magnetically attach to a metal garage door panel.

10. The garage door overlay section of claim 9, further comprising at least one window cutout made through the elongated magnetic core to accommodate at least one windows on a corresponding portion of the existing garage door panel after attachment.

11. A garage door magnetic overlay system, comprising: a plurality of magnetic overlay sections each overlay section configured for attaching to a front surface panel of an existing metal garage door to renovate and change the appearance of the existing garage door, wherein each of said magnetic overlay sections is comprised of a magnetic steel core with a matte front surface and a high-friction coating on a rear surface; also wherein at least one of the plurality of magnetic overlay sections is a top overlay section, and wherein at least one of the plurality of magnetic overlay sections is a bottom overlay section.

12. The garage door magnetic overlay system of claim 1, wherein at least one of the magnetic overlay section comprises a beveled overlapping edge to a panel of the existing garage door.

13. The garage door magnetic overlay system of claim 1, further comprising a printed or painted decorative design.

14. The garage door magnetic overlay system of claim 1, wherein the matte front surface comprises a painted surface, a vinyl film coating, an acrylic-urethane-elastomeric coating, a urethane coating, a plastic film, or a liquid vinyl coating.

15. A method for renovating a garage door, comprising:
constructing a plurality of magnetic garage door overlays each having a magnetized steel core and said magnetic garage door overlays each further comprising a matte printed front surface and a high-friction coating on the rear surface of each of said overall, and at least two of said plurality of garage door overlays further comprising at least one overlapping beveled edge; and
attaching magnetically said plurality of magnetic overlay sections to a front side of each panel of a of an existing metal garage door.

16. The method of claim 15, wherein said matte printed front surface of each of the plurality of garage door overlays further comprising UV inhibitors.
